(19) United States
(12) Patent Application Publication
(10) Pub. No.: US 2024/0046305 A1
(43) Pub. Date: Feb. 8, 2024

(54) MULTI-BOOTH TRAFFIC ALLOCATION METHODS AND APPARATUSES

(71) Applicant: Alipay (Hangzhou) Information Technology Co., Ltd., Hangzhou (CN)

(72) Inventors: Xingyu Lu, Hangzhou (CN); Qintong Wu, Hangzhou (CN); Wenliang Zhong, Hangzhou (CN)

(73) Assignee: Alipay (Hangzhou) Information Technology Co., Ltd., Hangzhou (CN)

(21) Appl. No.: 18/227,783

(22) Filed: Jul. 28, 2023

(30) Foreign Application Priority Data
Jul. 29, 2022 (CN) 202210905783.2

(51) Int. Cl. G06Q 30/0242

(52) U.S. Cl. CPC G06Q 30/0244; G06Q 30/0246

(57) ABSTRACT

A multi-booth traffic allocation scheme for multiple users if provided. In an implementation, an exposure probability of each booth and a unit traffic revenue and corresponding unit resource consumption of each candidate display object for each user are obtained. An optimization objective and a resource consumption constraint corresponding to a multi-booth traffic allocation scheme are constructed. The constructed optimization objective includes a sum value of traffic revenues for each user under the multi-booth traffic allocation scheme. The traffic revenues for each user are determined based on the exposure probability of each booth, a booth allocation scheme of candidate display objects, and the unit traffic revenue of each candidate display object. A multi-booth traffic allocation scheme when the resource consumption constraint is satisfied and the optimization objective is maximized is determined.

### CROSS-REFERENCE TO RELATED APPLICATIONS

This application claims priority to Chinese Patent Application No. 202210905783.2, filed on Jul. 29, 2022, which is hereby incorporated by reference in its entirety.

### TECHNICAL FIELD

Some embodiments of this specification usually relate to the field of traffic allocation, and in particular, to multi-booth traffic allocation methods and apparatuses.

### BACKGROUND

Traffic allocation is one of the fundamental problems in many applications, such as online advertising allocation with a guarantee contract, and product recommendation under resource constraints. Traffic allocation schemes estimate revenues generated by unit traffic, take resource consumption (for example, inventories and budgets) caused by the traffic into account, and finally generate recommendation results that satisfy efficiency maximization under resource constraints. Existing traffic allocation schemes are usually single-booth traffic allocation schemes, that is, display objects are allocated to a single booth. However, in some application scenarios, a group of display objects needs to be allocated to multiple booths for display, that is, multi-booth traffic allocation is needed. For example, in the case of information flow products or search result pages, there are multiple booths to provide users with content display, that is, display objects are exhibited on the multiple booths for users to browse. During the multi-booth traffic allocation, because display objects at a specific booth are more likely to be exposed to users (that is, there are position deviations) and contents of display objects are diverse, directly applying single-booth traffic allocation schemes to multi-booth traffic allocation can lead to poor performance.

### SUMMARY

In view of the described above, some embodiments of this specification provide multi-booth traffic allocation methods and apparatuses. By using the multi-booth traffic allocation methods and apparatuses, accuracy of multi-booth traffic allocation can be improved by excavating a position deviation by using a display way based on a display page or historical booth browsing behavior of a user, and introducing the position deviation into an optimization objective of traffic allocation.

According to an aspect of some embodiments of this specification, a method for determining a multi-booth traffic allocation scheme for multiple users is provided, including following: An exposure probability of each booth and a unit traffic revenue and corresponding unit resource consumption of each candidate display object for each user are obtained; an optimization objective and a resource consumption constraint corresponding to a multi-booth traffic allocation scheme are constructed based on the exposure probability of each booth and the unit traffic revenue and the corresponding unit resource consumption of each candidate display object for each user; and a multi-booth traffic allocation scheme when the resource consumption constraint is satisfied and the optimization objective is maximized is determined, where the multi-booth traffic allocation scheme includes a booth allocation scheme of candidate display objects for each user, where the optimization objective includes a sum value of traffic revenues for each user under the multi-booth traffic allocation scheme, the corresponding traffic revenue for each user is determined based on the exposure probability of each booth, a unit traffic revenue of each candidate display object for the user, and a booth allocation scheme of the candidate display objects for the user, the resource consumption constraint includes that a stun of resource consumption corresponding to each user is not greater than a predetermined threshold, and the resource consumption corresponding to each user is determined based on the exposure probability of each booth, unit resource consumption of each candidate display object for the user, and a booth allocation scheme of the candidate display objects for the user.

Optionally, in an example of the above-mentioned aspect, the optimization objective includes a sum value of traffic revenues and content information entropy for each user under the multi-booth traffic allocation scheme.

Optionally, in an example of the above-mentioned aspect, in the optimization objective, a trade-off parameter is set between the traffic revenues and the content information entropy for each user.

Optionally, in an example of the above-mentioned aspect, a multi-booth traffic allocation scheme when the resource consumption constraint is satisfied and the optimization objective is maximized is determined, including following: The multi-booth traffic allocation scheme when the resource consumption constraint is satisfied and the optimization objective is maximized is determined by using a random arrangement model.

Optionally, in an example of the above-mentioned aspect, the multi-booth traffic allocation scheme when the resource consumption constraint is satisfied and the optimization objective is maximized is determined by using a random arrangement model, including following: The following process for determining a traffic allocation scheme is sequentially performed for each user based on a user arrival order in the random arrangement model: A random traffic allocation request from a current arriving user is received, where the random traffic allocation request includes a unit traffic revenue and corresponding unit resource consumption of each candidate display object for the current arriving user; a first expected number of exposure times of each candidate display object on a display page is determined by using an efficient pooling projection algorithm based on a current dual variable and the unit traffic revenue and the corresponding unit resource consumption of each candidate display object for the current arriving user; a second expected number of exposure times of each candidate display object on the display page is determined based on a remaining resource consumption limit; a booth allocation scheme of candidate display objects for the current arriving user is restored by using a roulette exchange allocation algorithm based on the second expected number of exposure times of each candidate display object on the display page; and the current dual variable is updated based on the first expected number of exposure times of each candidate display object on the display page, where the updated current dual variable serves as a current dual variable in a next process for determining a traffic allocation scheme.

Optionally, in an example of the above-mentioned aspect, the current dual variable is updated based on the first expected number of exposure times of each candidate display object on the display page, including following: Gradient information of dual variables is determined based on the first expected number of exposure times of each candidate display object on the display page; and the current dual variable is updated based on the gradient information by using a projected subgradient descent algorithm.

Optionally, in an example of the above-mentioned aspect, a first expected number of exposure times of each candidate display object on a display page is determined by using an efficient pooling projection algorithm based on a current dual variable and the unit traffic revenue and the corresponding unit resource consumption of each candidate display object for the current arriving user, including following: candidate display objects in a candidate display object set for the current arriving user are arranged in descending order based on a contribution value of a maximum objective of the candidate display objects; the candidate display objects arranged in descending order are divided into blocks to obtain initial display object blocks, and an efficiency value of each initial display object block is determined based on a contribution value of a maximum objective and an exposure probability of each display object in the initial display object block: the following process is cyclically performed until efficiency values of all display object blocks in a display object block set for the current arriving user are strictly decreased in sequence: It is determined whether a display object block whose efficiency value is not great than an efficiency value of a display object block immediately following the display object block exists in a current display object block set: and in response to existence of a display object block whose efficiency value is not greater than an efficiency value of a display object block immediately following the display object block, the display object block and the display object block immediately following the display object block are merged into a new display object block, and an efficiency value of the new display object block is determined based on a contribution value of a maximum objective of each display object in the new display object block for the current arriving user and an exposure probability of each display object, or in response to nonexistence of a display object block whose efficiency value is not greater than an efficiency value of a display object block immediately following the display object block, the first expected number of exposure times of each candidate display object on the display page is determined based on an efficiency value of a display object block including each display object and a contribution value of a maximum objective of each candidate display object for the current arriving user.

Optionally, in an example of the above-mentioned aspect, a booth allocation scheme of candidate display objects for the current arriving user is restored by using a roulette exchange allocation algorithm based on the second expected number of exposure times of each candidate display object on the display page, including following: The following process is cyclically performed for each candidate display object in the candidate display object set for the current arriving user: In response to a number of allocated exposure times of current candidate display objects being greater than a second expected number of exposure times of the current candidate display objects, the current candidate display objects are merged into a display object index set to be exchanged; or in response to the number of allocated exposure times of the current candidate display objects being not greater than the second expected number of exposure times of the current candidate display objects, booth exchange between the current candidate display objects and the display objects in the display object index set is performed in a roulette exchange way based on an exchange probability between the current candidate display objects and each display object in the display object index set, the number of allocated exposure times of the current candidate display objects is updated to the second expected number of exposure times of the current candidate display objects, a number of allocated exposure times of the exchanged display objects is updated based on the number of allocated exposure times and an exchange probability of the exchanged display objects and the number of allocated exposure times of the current candidate display objects, and the exchanged display objects is removed from the display object index set to be exchanged when the updated number of allocated exposure times of the exchanged display objects is equal to a second expected number of exposure times of the exchanged display objects.

According to another aspect of some embodiments of this specification, an apparatus for determining a multi-booth traffic allocation scheme for multiple users is provided, including: an information acquisition unit, configured to obtain an exposure probability of each booth and a unit traffic revenue and corresponding unit resource consumption of each candidate display object for each user; an optimization objective determining unit, configured to construct an optimization objective and a resource consumption constraint corresponding to a multi-booth traffic allocation scheme based on the exposure probability of each booth and the unit traffic revenue and the corresponding unit resource consumption of each candidate display object for each user; and a traffic allocation unit, configured to determine a multi-booth traffic allocation scheme when the resource consumption constraint is satisfied and the optimization objective is maximized, where the multi-booth traffic allocation scheme includes a booth allocation scheme of candidate display objects for each user, where the optimization objective includes a sum value of traffic revenues for each user under the multi-booth traffic allocation scheme, the corresponding traffic revenue for each user is determined based on the exposure probability of each booth, a unit traffic revenue of each candidate display object for the user, and a booth allocation scheme of the candidate display objects for the user, the resource consumption constraint is that a sum of resource consumption for each user is not greater than a predetermined threshold, and the resource consumption corresponding to each user is determined based on the exposure probability of each booth, unit resource consumption of each candidate display object for the user, and a booth allocation scheme of the candidate display objects for the user.

According to still another aspect of some embodiments of this specification, an apparatus for determining a multi-booth traffic allocation scheme for multiple users is provided, including: at least one processor, a memory coupled to the at least one processor, and a computer program stored in the memory, where the at least one processor executes the computer program to implement the method for determining a multi-booth traffic allocation scheme for multiple users as described above.

According to yet another aspect of some embodiments of this specification, a computer readable storage medium is provided, where executable instructions are stored in the computer readable storage medium, and when the instructions are executed, a processor is enabled to perform the method for determining a multi-booth traffic allocation scheme for multiple users as described above.

According to still yet another aspect of some embodiments of this specification, a computer program product is provided, including a computer program, where the computer program is executed by a processor to implement the method for determining a multi-booth traffic allocation scheme for multiple users as described above.

### BRIEF DESCRIPTION OF THE DRAWINGS

Further understanding of the essence and advantages of the content of this specification can be realized by referring to the following accompanying drawings. In the accompanying drawings, similar components or features can have the same reference numerals.

FIG. 1A and FIG. 1B are example schematic diagrams illustrating single-booth traffic allocation and multi-booth traffic allocation, respectively.

FIG. 2 is an example flowchart illustrating a multi-booth traffic allocation method, according to some embodiments of this specification.

FIG. 3 is an example flowchart illustrating a process for determining a multi-booth traffic allocation scheme based on a random arrangement model, according to some embodiments of this specification.

FIG. 4 is an example flowchart illustrating a process for determining a first expected number of exposure times based on an efficient pooling projection algorithm, according to this specification.

FIG. 5 is an example flowchart illustrating a process for restoring a booth allocation scheme based on a roulette exchange algorithm, according to some embodiments of this specification.

FIG. 6 is an example block diagram illustrating a traffic allocation apparatus, according to some embodiments of this specification.

FIG. 7 is an example block diagram illustrating a traffic allocation unit, according to some embodiments of this specification.

FIG. 8 is an example schematic diagram illustrating a traffic allocation apparatus implemented based on a computer system, according to some embodiments of this specification.

### DESCRIPTION OF EMBODIMENTS

The subject matter described here will be discussed now with reference to example implementations. It should be understood that these implementations are merely discussed to enable a person skilled in the art to better understand and implement the subject matter described in this specification, and are not intended to limit the protection scope, applicability, or examples described in the claims. The functions and arrangements of the elements under discussion can be changed without departing from the protection scope of the content of this specification. Various processes or components can be omitted, replaced, or added in the examples as needed. For example, the described methods can be performed in a different order from that described, and various steps can be added, omitted or combined. In addition, features described for some examples can also be combined in other examples.

As used in this specification, the term “include” and its variant are inclusive, meaning “including but not limited to”. The term “based on” means “based on at least a part”. The terms “one embodiment” and “an embodiment” indicate “at least one embodiment”. The term “another embodiment” indicates “at least one other embodiment”. The terms “first”, “second”, etc. can refer to different objects or the same object. The following can include other definitions, whether explicit or implicit. Unless explicitly stated in the context, the definition of a term is consistent throughout this specification.

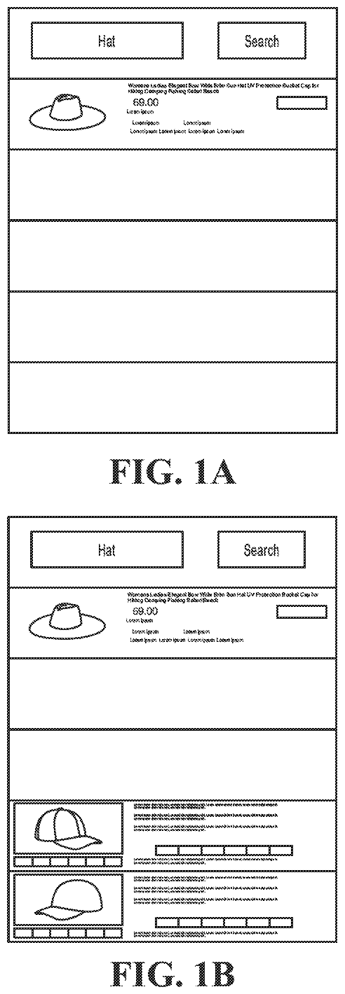

Traffic allocation schemes estimate revenues generated by unit traffic, take resource consumption (for example, inventories and budgets) caused by the traffic into account, and finally generate recommendation results that satisfy efficiency maximization under resource constraints. Existing traffic allocation schemes are usually single-booth traffic allocation schemes, that is, display objects are allocated to a single booth. FIG. 1A is an example schematic diagram illustrating a single-booth traffic allocation scheme. In this example, the first line is a search bar and a search button, and the second to sixth lines are display positions of search results. After “hat” is entered in the search bar, one search result is provided only at the second line (the first booth) of a search result page.

However, in some application scenarios, a group of display objects needs to be allocated to multiple booths for display, that is, multi-booth traffic allocation is needed. For example, in the case of information flow products or search result pages, there are multiple booths to provide users with content display, that is, display objects are exhibited on the multiple booths for exposure to user for browsing. FIG. 1B is an example schematic diagram illustrating a multi-booth traffic allocation scheme. In this example, after “hat” is entered in the search bar, one search result is provided at each of the first booth, the fourth booth and the fifth booth of the search result page, so that three search results are displayed on the search result page.

During the multi-booth traffic allocation, because display objects at a specific booth are more likely to be exposed to users (that is, there are position deviations) when the user are browsing and contents of display objects (i.e., display contents) are diverse, while single-booth traffic allocation schemes do not take position deviations and diversity of display contents into account, directly applying single-booth traffic allocation schemes to multi-booth traffic allocation can lead to poor performance.

In view of this, some embodiments of this specification propose a multi-booth traffic allocation scheme. In the traffic allocation scheme, accuracy of multi-booth traffic allocation can be improved by excavating a position deviation by using a display way based on a display page or historical booth browsing behavior of a user, and introducing the position deviation into an optimization objective of traffic allocation. In addition, by further introducing content information entropy for reflecting content diversity into the optimization objective, the content diversity is further considered during traffic allocation, thereby further improving accuracy of multi-booth traffic allocation.

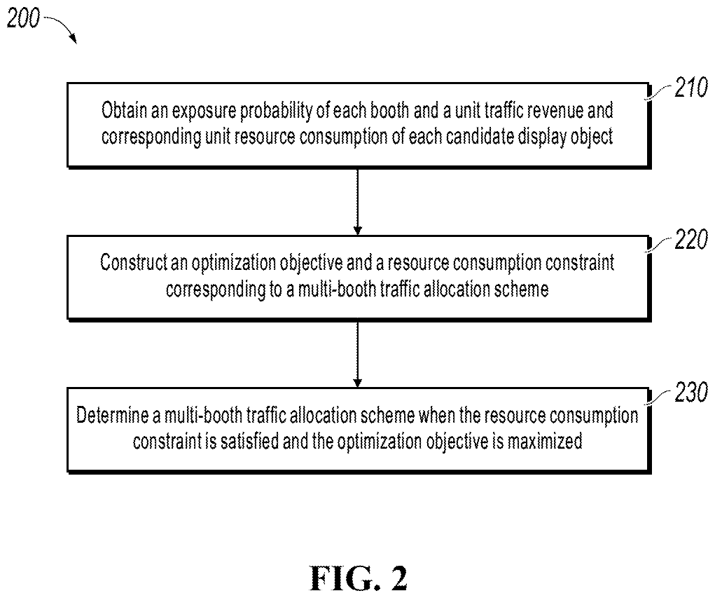

A traffic allocation method and a traffic allocation apparatus according to some embodiments of this specification are described below with reference to accompanying drawings. FIG. 2 is an example flowchart illustrating a multi-booth traffic allocation method 200, according to some embodiments of this specification.

As shown in FIG. 2, in step 210, an exposure probability of each booth and a unit traffic revenue and corresponding unit resource consumption of each candidate display object for each user are obtained. In this specification, the term “booth” refers to a display position on a display page. Examples of display pages can include, but are not limited to, various types of display pages, such as search result pages, information flow product pages, and advertisement display pages of entity advertising devices. The term “exposure probability of booths” refers to the probability (possibility) of exposing each booth on a display page to users. The exposure probability of each booth can be determined based on the display way of the display page or historical booth browsing behavior of users. The display way of the display page is, for example, to perform carousel display of display objects on the display page at a given time interval, so that the exposure probability of each booth can be determined based on an arrangement position of each booth on the display page. Or historical booth browsing behavior of users can be collected, and distribution modeling can be performed based on the historical booth browsing behavior of the users by using a position-based click model, to determine the exposure probability of each booth. The determined exposure probability of each booth can reflect the position deviation when the users are browsing, that is, there are different probabilities of exposing display objects at different booths to the users. In this specification, examples of the term “display object” can include, but are not limited to, search results, advertisements, pushed contents, and recommended goods.

The unit traffic revenue of the candidate display object for users refers to a revenue generated each time the candidate display object is exposed to users. The term “revenue” can refer to a fee or equivalent paid by a candidate display object owner to a display platform each time the candidate display object is exposed to users. For example, in application scenarios of advertising recommendation, the unit traffic revenue of the candidate display object for users refers to a fee paid by an advertiser to an advertising platform or an equivalent such as “traffic” each time an advertisement is exposed to users. In some embodiments, unit traffic revenues of candidate display objects for users can vary depending on different users and different candidate display objects. For example, a unit traffic revenue r_{a,b} is generated when candidate display objects a are provided to users b. The unit traffic revenue r_{a,b} changes when either candidate display objects a or users b change. In some embodiments, users b can be classified, and for users of the same classification, the generated unit traffic revenue r_{a,b} is the same when candidate display objects a are certain. In some embodiments, candidate display objects a can be classified, and for candidate display objects of the same classification, the generated unit traffic revenue r_{a,b} is the same when users b are certain. In some embodiments, for all users b, the generated unit traffic revenue r_{a,b} can be the same when candidate display objects a are certain. Or for all candidate display objects a, the generated unit traffic revenue r_{a,b} is the same when users b are certain. The unit traffic revenue of the candidate display object for users is usually estimated in advance, or determined through pre-negotiation between a display object owner and a display platform.

The unit resource consumption of the candidate display object for users refers to the amount of resources consumed each time the candidate display object is exposed to users. In this specification, the term “resource” can refer to platform resources, such as platform traffic, allocated by the display platform to the display object owner. Resources can include multi-dimension resources, such as k-dimensional resources (k resources). Similarly, the unit resource consumption of candidate display objects for users is usually estimated in advance.

Usually, the exposure probability of each booth and the unit traffic revenue and the corresponding unit resource consumption of each candidate display object for each user are prepared in advance and stored in a storage device. When multi-booth traffic allocation is performed, the exposure probability of each booth and the unit traffic revenue and the corresponding unit resource consumption of each candidate display object for each user are obtained from the storage device.

After the exposure probability of each booth and the unit traffic revenue and the corresponding unit resource consumption of each candidate display object for each user are obtained as describe above, in step 220, an optimization objective and a resource consumption constraint corresponding to a multi-booth traffic allocation scheme are constructed based on the exposure probability of each booth and the unit traffic revenue and the corresponding unit resource consumption of each candidate display object for each user.

In an example, the constructed optimization objective can include a sum value of traffic revenues for each user under the multi-booth traffic allocation scheme. The corresponding traffic revenue for each user can be determined based on the exposure probability of each booth, the unit traffic revenue of each candidate display object for the user, and a booth allocation scheme of the candidate display objects for the user. In addition, the resource consumption constraint constructed can include that a sum of resource consumption corresponding to each user is not greater than a predetermined threshold. The resource consumption corresponding to each user is determined based on the exposure probability of each booth, the unit resource consumption of each candidate display object for the user, and a booth allocation scheme of the candidate display objects for the user.

For example, display objects and users can be represented as two ends of a bipartite graph GN=(A,T,E), where T represents a user set, and A represents all display objects. Candidate display objects for any user t∈T can be represented by a subset Eₜ of an edge set E={(t,a):t∈T, a∈Eₜ}. In addition, a booth allocation scheme of candidate display objects for user t is defined as a decision matrix xₜ∈[0,1]^{A}, that is, the decision matrix xₜ determines how to allocate the candidate display objects (N candidate display objects) to N booths for user t, where each item x_{t,a,n} in the decision matrix xₜ is indexed by candidate display object a and booth n.

In embodiments of this specification, a traffic allocation scheme necessarily satisfies the following conditions:

Each booth is necessarily allocated to one display object.

One display object can be allocated to one booth at most.

The above-mentioned conditions can be transformed into constraints as shown in equation (1):

$$χ = [ \begin{matrix}{\sum }_{a ∈ {E}_{t}} {x}_{t , a , n} = 1 , ∀ t ∈ 𝕋 , 1 \leq n \leq N \\ {\sum }_{1 \leq n \leq N} {x}_{t , a , n} \leq 1 , ∀ t ∈ 𝕋 , a ∈ {E}_{t}\end{matrix} ] \qquad ( 1 )$$

To represent a position deviation between different booths, position deviation vector c=(c₁, c₂ . . . , c_{N})∈(0,1]^{N} is introduced, where cₙ represents an exposure probability of booth n. To simplify the description, position deviation vector c is assumed to be the same for all users, and satisfies the following non-increasing conditions without losing generality: 1≥c₁≥c₂≥ . . . >0. In some embodiments, position deviation vector c can also be assumed to be different for different users.

Therefore, the multi-booth allocation problem can be linearly modeled as having the optimization objective as shown in equation (2) and the resource constraint as shown in equation (3):

max_{X∈}_{_{χ}}Σₜ₌₁^{T}(rₜ)^{T}Xₜc (2),

Σₜ₌₁^{T}(Mₜ)^{T}Xₜc≤TB (3),

where T represents a number of users, rₜ represents a unit traffic vector of each candidate display object for user t, (·)^{T} represents a transposition operation, Xₜ represents the decision matrix for user t (that is, a booth allocation scheme of each candidate display object for user t), c represents the position deviation vector, Mₜ represents a unit resource consumption matrix of each candidate display object for user t, and B represents a resource constraint amount for a single user that is allocated by the display platform to the display object owner. Resources can have multiple dimensions or multiple resources. The unit resource consumption matrix Mₜ can be an N×k-dimensional matrix, where N is a number of candidate display objects, and k is the resource dimension.

In another example, content information entropy can be further introduced into the constructed optimization objective, so that the constructed optimization objective includes a sum value of traffic revenues for each user under the multi-booth traffic allocation scheme and the content information entropy. The content information entropy is used to measure fairness of traffic allocated to different display object owners on each display page, and reflects the content diversity of the display page.

Therefore, the optimization objective can be constructed as shown in equation (4):

max_{X∈}_{_{χ}}Σₜ₌₁^{T}((rₜ)^{T}Xₜc+ [symbol] (Xₜc)) (4)

where [symbol] (·) represents the content information entropy and can determine the following as shown in equation (5):

[symbol]

(Xₜc)=−Σ_{a∈A}_{ₜ}x_{t,a}c log(x_{t,a}c) (5)

Optionally, in some embodiments, in the optimization objective, a trade-off parameter α can be further set between the traffic revenue and the content information entropy for each user. The trade-off parameter α is used to control the trade-off consideration of the traffic revenue and content information entropy for each user.

Therefore, the optimization objective can be constructed as shown in equation (6):

max_{X∈}_{_{χ}}Σₜ₌₁^{T}((rₜ)^{T}Xₜc+α [symbol] (Xₜc)) (6).

After the optimization objective and the resource constraint are determined as describe above, in step 230, a multi-booth traffic allocation scheme when the resource consumption constraint is satisfied and the optimization objective is maximized is determined, where the determined multi-booth traffic allocation scheme includes a booth allocation scheme of candidate display objects for each user.

In an example, Lagrange dual transformation can be performed on the optimization objective when the multi-booth traffic allocation scheme is determined. Then dual variables are solved, and the multi-booth traffic allocation scheme is determined based on the dual variables.

For example, for the optimization objective shown in equation (6). Lagrange dual transformation is performed to obtain:

min_{λ≥0}max_{X∈}_{_{χ}}L(λ,X)=Σₜ₌₁^{T}[(rₜ)^{T}Xₜc+α [symbol] (Xₜc)]+λ^{T}(TB−Σₜ₌₁^{T}(Mₜ)^{T}Xₜc) (7)

Then equation (7) is solved to determine the dual variable λ, and then a decision matrix Xₜ for each user is determined based on the dual transformation λ, thereby determining the multi-booth traffic allocation scheme.

In an example, the multi-booth traffic allocation scheme can be determined by using a random arrangement model when the resource consumption constraint is satisfied and the optimization objective is maximized. In the random arrangement model, arriving users T can be selected at the beginning adversarially, and a user arrival order is randomly arranged.

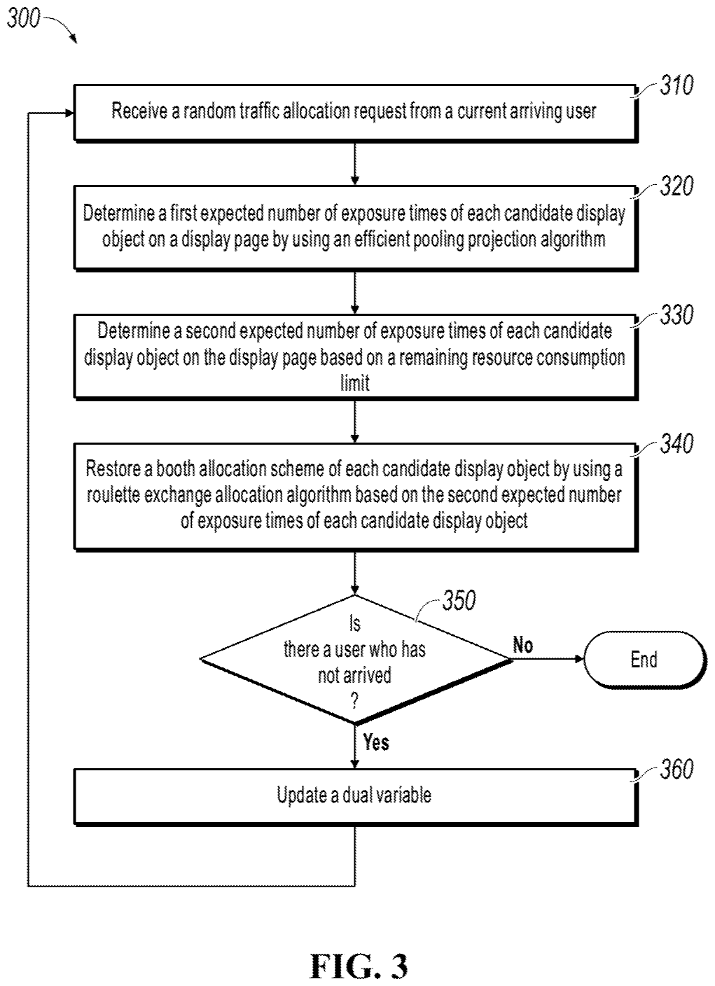

FIG. 3 is an example flowchart illustrating a process 300 for determining a multi-booth traffic allocation scheme based on a random arrangement model, according to some embodiments of this specification. In the example of FIG. 3, the process for determining a traffic allocation scheme is sequentially performed for each user t based on the user arrival order in the random arrangement model.

As shown in FIG. 3, in step 310, a random traffic allocation request is received from a current arriving user t, where the received random traffic allocation request includes a unit traffic revenue and corresponding unit resource consumption of each candidate display object for the current arriving user t. The unit traffic revenue of each candidate display object forms a unit traffic revenue vector rₜ, and the unit traffic resource consumption of each candidate display object forms a unit resource consumption matrix Mₜ. An element r_{t,a} in the unit traffic revenue vector rₜ represents the unit traffic revenue for the candidate display object a. An element M_{t,a,k} in the unit resource consumption matrix Mₜ represents an element corresponding to the kth-dimensional resource consumption for the user t and the display object a.

In step 320, a first expected number ŷₜ of exposure times of each candidate display object on a display page is determined by using an efficient pooling projection algorithm based on the current dual variable λₜ and the unit traffic revenue vector rₜ and the corresponding unit resource consumption matrix Mₜ of each candidate display object for the current arriving user t. Here, the first expected number ŷₜ of exposure times of each candidate display object on the display page is equivalent to the items XₜC in the above-mentioned equations (4)-(6). The first expected number ŷₜ of exposure times is an expected number of exposure times obtained without considering the resource constraint.

By using an expected number yₜ of exposure times, optimization objectives and resource constraints in equations (6) and (3) can be transformed into the following:

max_{y∈Y}Σₜ₌₁^{T}((rₜ)^{T}yₜ+α [symbol] (yₜ));

Σₜ₌₁^{T}(Mₜ)^{T}yₜ≤TB.

A domain constraint Y is defined as:

$$𝓎 = [ \begin{matrix}{sup}_{{E}_{t} ( n )} {\sum }_{a ∈ {E}_{t} ( n )} {y}_{t , a} & \leq {\sum }_{s = 1}^{n} {c}_{s} , ∀ t ∈ 𝕋 , n < N \\ {\sum }_{a ∈ {E}_{t}} {y}_{t , a} & = {\sum }_{n = 1}^{N} {c}_{n} , ∀ t ∈ 𝕋\end{matrix} ]$$

where Eₜ(n) represents a subset of a display object set Eₜ with a size of n. The domain constraint Y means that a cumulative number of exposure times of first n display objects cannot exceed an exposure times capacity of first n booths in the multi-booth allocation.

Then, a dual variable λ with a resource constraint is introduced to obtain a Lagrangian dual in matrix form in equation (6), and the optimization objective can be further transformed into a minimum and a maximum under an exchange strong dual as follows:

min_{λ≥0}max_{y∈Y}L(λ,y)=Σₜ₌₁^{T}[(rₜ)^{T}yₜ+α [symbol] (yₜ)]+λ^{T}(TB−Σₜ₌₁^{T}(Mₜ)^{T}yₜ)

It is worthwhile to note that the described above is only an example. When the optimization objective has other forms, a Lagrangian dual expression of a corresponding form can be obtained.

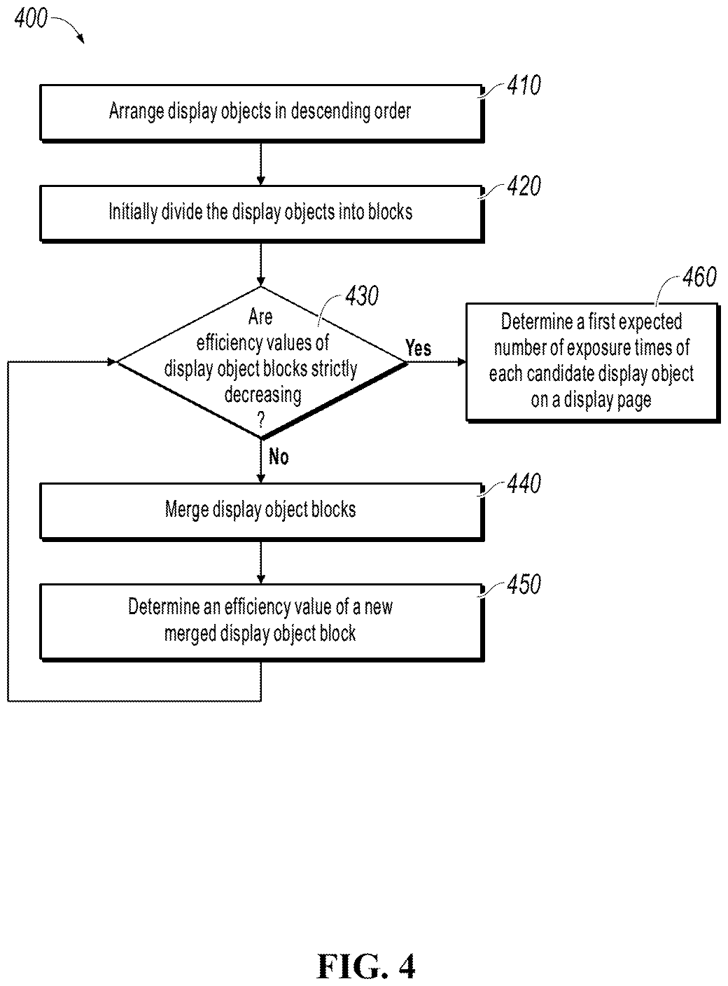

FIG. 4 is an example flowchart illustrating a process 400 for determining a first expected number of exposure times based on an efficient pooling projection algorithm, according to this specification.

As shown in FIG. 4, in step 410, a contribution value v_{t,a} of a maximum objective of each candidate display object a in a candidate display object set Eₜ for the current arriving user t is determined based on a unit traffic revenue r_{t,a}, unit resource consumption M_{t,a} and a current dual variable λₜ of the candidate display object a, and the candidate display objects a in the candidate display object set Eₜ for the current arriving user t are arranged in descending order based on a contribution value v_{t,a} of a maximum objective of each candidate display object a.

For example, when dual variables λₜ are given, the contribution value v_{t,a} and an efficiency value e_{t,a} of the maximum objective for the user t and the display object a can be obtained as follows:

$${v}_{t , a} := exp ( \frac{{r}_{t , a} - {\sum }_{k} {λ}_{t , k} {m}_{t , a , k}}{α} ) , {e}_{t , a} := \frac{{v}_{t , a}}{{y}_{t , a}} ,$$

where k represents the dimension of resource constraints, λ_{t,k} represents a dual variable component of λₜ in the kth dimension, m_{t,a,k} represents elements corresponding to the display object a and the kth dimension, and α represents a trade-off parameter. Therefore, the candidate display objects in the candidate display object set Eₜ with a size of Aₜ can be arranged in descending order based on the following sequence of contribution values of the corresponding maximum objectives: v_{t,1}≥v_{t,2}≥ . . . ≥v_{t,A}_{ₜ}, ∀t ϵ [symbol] .

In step 420, the candidate display objects in the candidate display object set Eₜ are initially divided into blocks, and an efficiency value of each initial display object block is determined.

For example, in an initialization stage (I=0), the ith display object can be allocated to the ith booth, so that all display objects Eₜ are decomposed into N+1 display object blocks { [symbol] ᵣ⁽⁰⁾}ₜ₌₁^{N+1} based on equation (8):

$${𝔹}_{r}^{( 0 )} := \{ \begin{matrix}\{ r \} , ∀ 1 \leq r \leq N \\ \{ a \vert N < a \leq {A}_{t} \} , r = N + 1\end{matrix} . \qquad ( 8 )$$

Then, the efficiency value of each initial display object block is determined based on equation (9):

$$E ( {𝔹}_{r} ) = \frac{{\sum }_{a ∈ {𝔹}_{r}} {v}_{t , a}}{{\sum }_{a ∈ {𝔹}_{r}} {c}_{a} II ( 1 \leq a \leq N )} , \qquad ( 9 )$$

where [symbol] (1≤a≤N) represents an indicator function.

For the indicator function (1≤a≤N), when a≤N, [symbol] (1≤a≤N)=1, and thus cₐ [symbol] (1≤a≤N)=cₐ. Otherwise [symbol] (1≤a≤N)=0, and thus cₐ [symbol] (1≤a≤N)=0.

Then, operations from step 430 to step 460 are cyclically performed until the obtained efficiency values of each display object block are strictly decreased in sequence.

In step 430, it is determined whether a display object block whose efficiency value is not great than an efficiency value of a display object block immediately following the display object block exists in a current display object block set.

If a display object block whose efficiency value is not greater than an efficiency value of a display object block immediately following the display object block exists, in step 440, the display object block and the display object block immediately following the display object block are merged into a new display object block. Then in step 450, an efficiency value of the new display object block is determined based on a contribution value v_{t,a} of a maximum objective of each display object in the new display object block for the current arriving user and an exposure probability cₐ of each display object. For example, the efficiency value of the new display object block can be determined based on equation (9).

After step 440 and step 450 are performed, the process returns to block 430, and a next cyclic process is performed by using the latest efficiency values of each display object block after the above-mentioned processing.

If a display object block whose efficiency value is not greater than an efficiency value of a display object block immediately following the display object block does not exist, in step 460, the first expected number of exposure times of each candidate display object on the display page is determined based on an efficiency value of a display object block including each display object and a contribution value of a maximum objective of each candidate display object for the current arriving user.

For example, when the display object a is in the display object block [symbol] r, the first expected number of exposure times of the candidate display objects a on the display page can be determined based on equation (10):

$${\hat{y}}_{t , a} = \frac{{v}_{t , a}}{E ( {𝔹}_{r} )} , ∀ a ∈ {𝔹}_{r} . \qquad ( 10 )$$

The first expected number ŷ_{t,a} of exposure times of each candidate display object a for the user t forms a first expected exposure times vector ŷₜ of the candidate display objects on the display page for the user t.

Referring to FIG. 3, after the first expected number of exposure times of each candidate display object on the display page for the user is determined as described above, in step 330, a second expected number of exposure times of each candidate display object on the display page is determined based on a remaining resource consumption limit. The second expected number of exposure times is an expected number of exposure times obtained considering the resource constraint.

For example, if the resource consumption (Mₜ)ŷₜ generated by the first expected number of exposure times of each candidate display object on the display page for the user is not greater than the remaining resource consumption limit, the first expected number ŷₜ of exposure times of each candidate display object on the display page for the user is determined as the second expected number \tilde{y}ₜ of exposure times of each candidate display object on the display page for the user. If the resource consumption (Mₜ)^{T}ŷₜ generated by the first expected number of exposure times of each candidate display object on the display page for the user is greater than the remaining resource consumption limit, the second expected number ŷₜ of exposure times of each candidate display object on the display page for the user is determined as 0.

The above-mentioned process for determining a second expected number of exposure times can be given by equation (11):

$${\tilde{y}}_{t} = \{ \begin{matrix}{\hat{y}}_{t} , if {\sum }_{s = 1}^{t - 1} {( {M}_{s} )}^{T} {\tilde{y}}_{s} + {( {M}_{t} )}^{T} {\hat{y}}_{t} \leq TB \\ 0 , if {\sum }_{s = 1}^{t - 1} {( {M}_{s} )}^{T} {\tilde{y}}_{s} + {( {M}_{t} )}^{T} {\hat{y}}_{t} > TB\end{matrix} , \qquad ( 11 )$$

where s represents users who have completed allocation, \tilde{y}ₜ and \tilde{y}ₛ represent second expected exposure times vectors for user t and user s, respectively. Mₛ represents a unit resource consumption matrix for user s, and ŷₜ represents the first expected exposure times vector for user t.

After the second expected exposure times vector of each candidate display object on the display page for user t is determined as describe above, in step 340, a booth allocation scheme Xₜ of candidate display objects for the current arriving user is restored by using a roulette exchange allocation algorithm based on the second expected number ŷₜ of exposure times of each candidate display object on the display page.

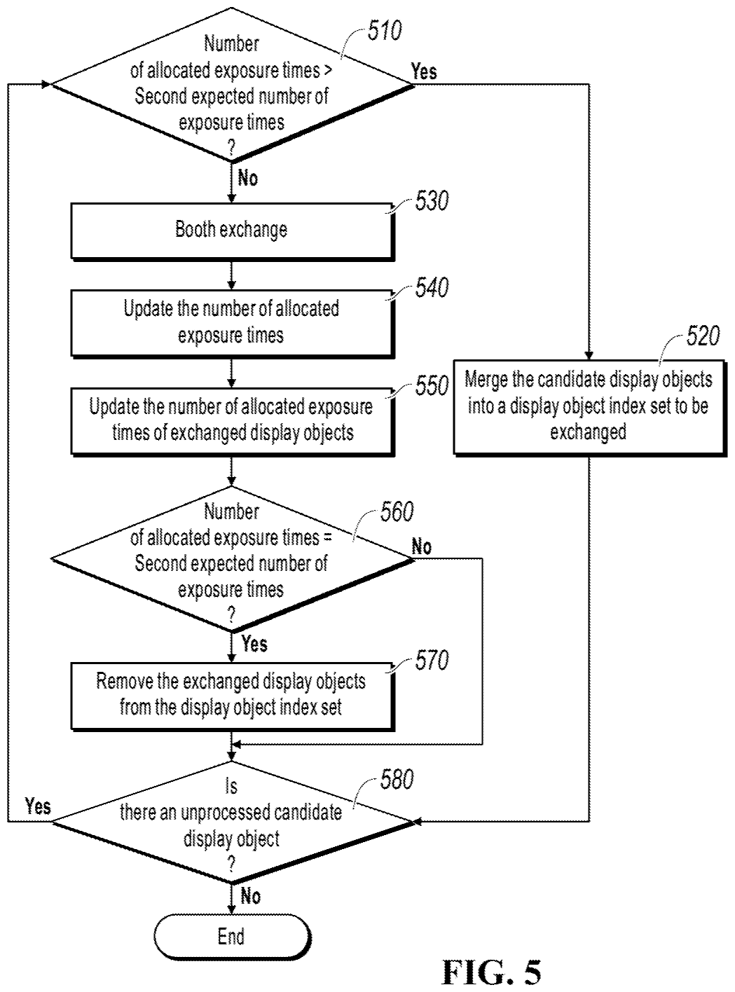

FIG. 5 is an example flowchart illustrating a process 500 for restoring a booth allocation scheme based on a roulette exchange algorithm, according to embodiments of this specification.

Initialization is first performed before the process shown in FIG. 5 is performed. Specifically, the initial booth of the display object a is initialized as booth a, that is, r(a)=a. In addition, the number of allocated exposure times of the display object a is initialized as y_{t,a}=cₐ [symbol] (1≤a≤N), ∀aϵEₜ, and an initial value of the display object index set s to be exchanged is an empty set, that is, [symbol] ={ }. Similarly, when a≤N, (1≤a≤N)=1, and thus y_{t,a}=cₐ. Otherwise (1≤a≤N)=0, and thus y_{t,a}=0.

Then for each candidate display object in the candidate display object for the current arriving user, the process from step 510 to step 580 is cyclically performed in sequence. Here, the candidate display objects in the candidate display object set can, for example, be arranged in descending order based on contribution values of maximum objectives as describe above.

As shown in FIG. 5, in step 510, it is determined whether a number y_{t,j} of allocated exposure times of a current candidate display object j is greater than a second expected number \tilde{y}_{t,j} of exposure times of the current candidate display object j.

If the number y_{t,j} of allocated exposure times of the current candidate display object j is greater than the second expected number \tilde{y}_{t,j} of exposure times of the current candidate display object j, in step 520, the current candidate display object j is merged into a display object index set [symbol] to be exchanged, that is, [symbol] = [symbol] ∪{j}.

If the number y_{t,j} of allocated exposure times of the current candidate display object j is not greater than the second expected number ŷ_{t,j} of exposure times of the current candidate display object, in step 530, booth exchange between the current candidate display objects and the display objects in the display object index set is performed in a roulette exchange way based on an exchange probability between the current candidate display objects and each display object in the display object index set. Specifically, an exchange probability pₛ between the current candidate display object j and each display object s in the display object index set s is determined, a first display object s₁ is selected from the display object index set s based on the determined exchange probability, and booths of the current candidate display object j and the first display object s₁ are exchanged.

The exchange probability pₛ of the display object s can be determined based on equation (12):

$${p}_{s} = \frac{{\tilde{y}}_{t , j} - {y}_{t , j}}{{y}_{t , s} - {y}_{t , j}} \cdot \frac{{\tilde{y}}_{t , s} - {y}_{t , s}}{{\sum }_{{S}^{′} {∈}_{3}} ( {\tilde{y}}_{t , {S}^{′}} - {y}_{t , {S}^{′}} )} . \qquad ( 12 )$$

In step 540, the number y_{t,j} of allocated exposure times of the current candidate display object j is updated to the second expected number of exposure times of the current candidate display object j, that is, y_{t,j}=\tilde{y}_{t,j}.

In step 550, the number pₛ_{₁} of allocated exposure times of the first display object s₁ is updated based on the exchange probability y_{t,s1}, the number y_{t,s1} of allocated exposure times of the first display object s₁, and the number y_{t,j} of allocated exposure times of the current candidate display object j.

For example, the number y_{t,s1} of allocated exposure times of the first display object s₁ can be updated based on equation (13):

y_{t,s}_{₁}=(1−pₛ_{₁})·y_{t,s}_{₁}+pₛ_{₁}·y_{t,j} (13).

In step 560, it is determined whether the updated number y_{t,s1} of allocated exposure times of the first display object s₁ is equal to the second expected number \tilde{y}_{t,s1} of exposure times of the first display object s₁. If the updated number y_{t,s1} of allocated exposure times of the first display object s₁ is equal to the second expected number \tilde{y}_{t,s1} of exposure times of the first display object s₁, in step 570, the first display object s₁ is removed from the display object index set s to be exchanged, and then the process proceeds to step 580.

If the updated number y_{t,s1} of allocated exposure times of the first display object s₁ is not equal to the second expected number \tilde{y}_{t,s1} of exposure times of the first display object s₁, the process proceeds to step 580.

In step 580, it is determined whether there is an unprocessed candidate display object. If there is no unprocessed candidate display object, the process ends. If there is an unprocessed candidate display object, the process returns to step 510, and a next roulette exchange process is performed.

By using the roulette exchange algorithm shown in FIG. 5, the number yₜ, of allocated exposure times of the display object j is compared with the second expected number y_{t,j} of exposure times in each round of processing, and when the number of allocated exposure times of the display object j is insufficient, compensation can be performed by overexposure of the display object in the display object index set S by performing the above-mentioned exchange operation.

After the booth allocation scheme of the corresponding display object is determined for the user t as describe above, in step 350, it is determined whether there is a user who has not arrived. If there is no user who has not arrived, the process ends.

If there is a user who has not arrived, in step 360, the current dual variable λₜ is updated based on the first expected number ŷₜ of exposure times of each candidate display object on the display page λₜ.

Specifically, gradient information g(λₜ) of the dual variable λₜ is determined based on the first expected number ŷₜ of exposure times of each candidate display object on the display page. For example, gradient information g(λₜ) of the dual variable λₜ can be determined by using equation g(λₜ):=B−(Mₜ)^{T}ŷₜ.

Then the current dual variable λₜ is updated by using the gradient information g(λₜ), and thus an updated dual variable λₜ₊₁ is obtained. The updated current dual variable λₜ₊₁ serves as a current dual variable in a next process for determining a traffic allocation scheme.

In an example, the current dual variable λₜ can be updated based on the gradient information g(λₜ) by using a projected subgradient descent algorithm. For example, the current dual variable can be updated based on the gradient information by using the following equation: λₜ₊₁=Proj_{λ≥0}{λₜ−ηg(λₜ)}, where η represents gradient update step size. The value of η can be given in advance.

After the update process for the dual variable λₜ is completed, the process returns to step 310, and the updated dual variable λₜ₊₁ is used to perform the booth allocation processing of display objects for a next arriving user.

By using the above-mentioned multi-booth traffic allocation method, accuracy of multi-booth traffic allocation can be improved by excavating a position deviation by using a display way based on a display page or historical booth browsing behavior of a user, and introducing the position deviation into an optimization objective of traffic allocation. In addition, by further introducing content information entropy for reflecting content diversity into the optimization objective, the content diversity is further considered during traffic allocation, thereby further improving accuracy of multi-booth traffic allocation.

By using the above-mentioned multi-booth traffic allocation method and by introducing the first expected number yₜ=xₜc of exposure times as an intermediate variable for the user t during optimization, multi-booth traffic allocation is decomposed into two stages, that is, the process of determining a first expected number yₜ of exposure times and the booth allocation process for the user t (that is, restoring a booth allocation scheme xₜ), thereby reducing the complexity of the process for determining multi-booth traffic allocation.

By using the above-mentioned multi-booth traffic allocation method, the computational complexity of the process for determining a first expected number yₜ of exposure times can be reduced by using an efficient pooling projection algorithm to determine the first expected number yₜ of exposure times for the user t. Two basic operations (that is, a comparison operation and a merging operation) are used in the efficient pooling projection algorithm, and its time complexity is O(1). N+1 blocks are initialized at the beginning and the algorithm merges at least two blocks in each iteration. Finally, the efficient pooling projection algorithm needs at most N iterations, and thus its time complexity is O(N).

By using the above-mentioned multi-booth traffic allocation method, a multi-booth allocation scheme xₜ for the user t is restored based on the second expected number of exposure times for the user t by using the roulette exchange algorithm, so that the multi-booth allocation scheme xₜ can be restored by probability sampling, thereby reducing the computational complexity of the restoration process. The main time cost of the roulette exchange algorithm is to calculate an exchange probability ps,∀sϵ [symbol] , and its complexity is linear with the size of the display object index set S, and the size of the display object index set S does not exceed N. In each round of j, an expected value w_{t,j} of the number of allocated exposure times is updated by using wt,j=\tilde{y}_{t,j}, so as to ensure that exchange operations are performed at most for Aₜ times. Therefore, the time complexity of the roulette exchange algorithm is O(N×Aₜ).

In the above-mentioned multi-booth allocation scheme, the complexity is O(Aₜ log Aₜ) starting from the sequencing of the candidate display object set Eₜ, and then the multi-booth traffic allocation scheme is determined by applying the efficient pooling projection algorithm and the roulette exchange algorithm, so that the scheme has a total complexity of O(N+NAₜ+Aₜ log Aₜ), and is linear with the fixed value Aₜ relative to a number N of booths.

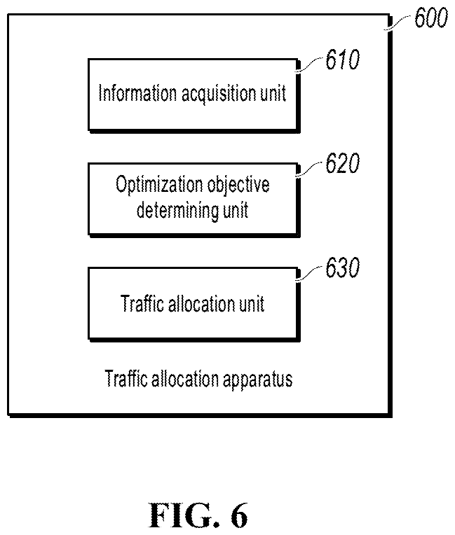

FIG. 6 is an example block diagram illustrating a traffic allocation apparatus 600, according to some embodiments of this specification. As shown in FIG. 6, the traffic allocation apparatus 600 includes an information acquisition unit 610, an optimization objective determining unit 620, and a traffic allocation unit 630.

The information acquisition unit 610 is configured to obtain an exposure probability of each booth and a unit traffic revenue and corresponding unit resource consumption of each candidate display object for each user. For operations of the information acquisition unit 610, references can be made to the operations as describe above in step 210 with reference to FIG. 2.

The optimization objective determining unit 620 is configured to construct an optimization objective and a resource consumption constraint corresponding to a multi-booth traffic allocation scheme based on the exposure probability of each booth and the unit traffic revenue and the corresponding unit resource consumption of each candidate display object for each user. For operations of the optimization objective determining unit 620, references can be made to the operations as describe above in step 220 with reference to FIG. 2.

In an example, the constructed optimization objective can include a sum value of traffic revenues for each user under the multi-booth traffic allocation scheme. The corresponding traffic revenue for each user can be determined based on the exposure probability of each booth, the unit traffic revenue of each candidate display object for the user, and a booth allocation scheme of the candidate display objects for the user. The resource consumption constraint constructed can be that a sum of resource consumption for each user is not greater than a predetermined threshold. The resource consumption corresponding to each user can be determined based on the exposure probability of each booth, the unit resource consumption of each candidate display object for the user, and a booth allocation scheme of the candidate display objects for the user.

In another example, content information entropy can be further introduced into the constructed optimization objective, so that the constructed optimization objective includes a sum value of traffic revenues for each user under the multi-booth traffic allocation scheme and the content information entropy. In another example, in the optimization objective, a trade-off parameter α can be further set between the traffic revenue and the content information entropy for each user.

The traffic allocation unit 630 is configured to determine a multi-booth traffic allocation scheme when the resource consumption constraint is satisfied and the optimization objective is maximized, where the multi-booth traffic allocation scheme includes a booth allocation scheme of candidate display objects for each user. For operations of the traffic allocation unit 630, references can be made to the operations as describe above in step 230 with reference to FIG. 2 and the operations as describe above with reference to FIG. 3 to FIG. 5.

In an example, the traffic allocation unit can determine the multi-booth traffic allocation scheme by using a random arrangement model when the resource consumption constraint is satisfied and the optimization objective is maximized.

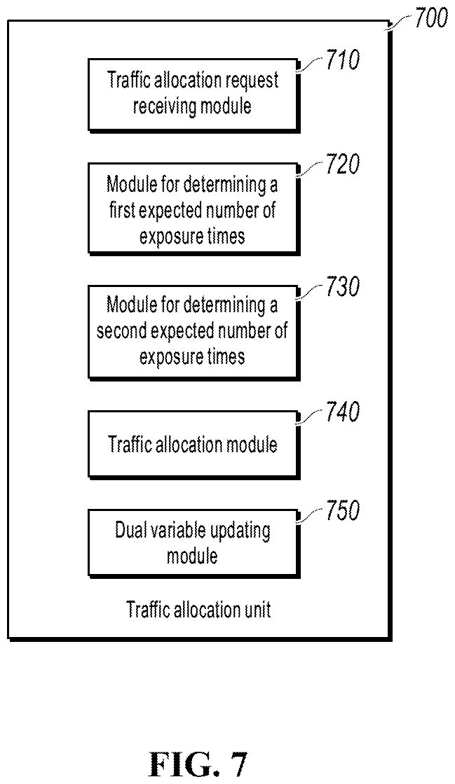

FIG. 7 is an example block diagram illustrating a traffic allocation unit 700, according to embodiments of this specification. As shown in FIG. 7, the traffic allocation unit 700 includes a traffic allocation request receiving module 710, a module 720 for determining a first expected number of exposure times, a module 730 for determining a second expected number of exposure times, a traffic allocation module 740, and a dual variable updating module 750.

The traffic allocation request receiving module 710, the module 720 for determining a first expected number of exposure times, the module 730 for determining a second expected number of exposure times, the traffic allocation module 740 and the dual variable updating module 750 sequentially determine a booth allocation scheme for each user based on a user arrival order in the random arrangement model.

Specifically, each time a booth allocation scheme for each user is determined, the traffic allocation request receiving module 710 is configured to receive a random traffic allocation request from a current arriving user, where the received random traffic allocation request includes a unit traffic revenue and corresponding unit resource consumption of each candidate display object for the current arriving user. For operations of the traffic allocation request receiving module 710, references can be made to the operations as describe above in step 310 with reference to FIG. 3.

The module 720 for determining a first expected number of exposure times is configured to determine a first expected number of exposure times of each candidate display object on a display page by using an efficient pooling projection algorithm based on a current dual variable and the unit traffic revenue and the corresponding unit resource consumption of each candidate display object for the current arriving user. For operations of the module 720 for determining a first expected number of exposure times, references can be made to the operations as describe above in step 320 with reference to FIG. 3.

In an example, the module 720 for determining a first expected number of exposure times is configured to arrange candidate display objects in a candidate display object set for the current arriving user in descending order based on a contribution value of a maximum objective of the candidate display objects: divide the candidate display objects arranged in descending order into blocks to obtain initial display object blocks, and determine an efficiency value of each initial display object block based on a contribution value of a maximum objective and an exposure probability of each display object in the initial display object block; cyclically perform the following process until efficiency values of all display object blocks in a display object block set for the current arriving user are strictly decreased in sequence: determine whether a display object block whose efficiency value is not great than an efficiency value of a display object block immediately following the display object block exists in a current display object block set: and in response to existence of a display object block whose efficiency value is not greater than an efficiency value of a display object block immediately following the display object block, merge the display object block and the display object block immediately following the display object block into a new display object block, and determine an efficiency value of the new display object block based on a contribution value of a maximum objective of each display object in the new display object block for the current arriving user and an exposure probability of each display object, or in response to nonexistence of a display object block whose efficiency value is not greater than an efficiency value of a display object block immediately following the display object block, determine the first expected number of exposure times of each candidate display object on the display page based on an efficiency value of a display object block including each candidate display object and a contribution value of a maximum objective of each candidate display object for the current arriving user.

The module 730 for determining a second expected number of exposure times is configured to determine a second expected number of exposure times of each candidate display object on the display page based on a remaining resource consumption limit. For operations of the module 730 for determining a second expected number of exposure times, references can be made to the operations as describe above in step 330 with reference to FIG. 3.

The traffic allocation module 740 is configured to restore a booth allocation scheme of candidate display objects for the current arriving user by using a roulette exchange allocation algorithm based on the second expected number of exposure times of each candidate display object on the display page. For operations of the traffic allocation module 740, references can be made to the operations as describe above in step 340 with reference to FIG. 3.

In an example, for each candidate display object in the candidate display object set for the current arriving user, the traffic allocation module 740 is configured to sequentially cyclically perform the following processes: in response to a number of allocated exposure times of current candidate display objects being greater than a second expected number of exposure times of the current candidate display objects, merge the current candidate display objects are into a display object index set to be exchanged: or in response to the number of allocated exposure times of the current candidate display objects being not greater than the second expected number of exposure times of the current candidate display objects, perform booth exchange between the current candidate display objects and the display objects in the display object index set in a roulette exchange way based on an exchange probability between the current candidate display objects and each display object in the display object index set, update the number of allocated exposure times of the current candidate display objects to the second expected number of exposure times of the current candidate display objects, update a number of allocated exposure times of the exchanged display objects based on the number of allocated exposure times and an exchange probability of the exchanged display objects and the number of allocated exposure times of the current candidate display objects, and remove the exchanged display objects from the display object index set to be exchanged when the updated number of allocated exposure times of the exchanged display objects is equal to a second expected number of exposure times of the exchanged display objects.

The dual variable updating module 750 is configured to update, when booth allocation scheme determining is not completed for all users, the current dual variable based on the first expected number of exposure times of each candidate display object on the display page, where the updated current dual variable serves as a current dual variable in a next process for determining a traffic allocation scheme. In an example, the dual variable updating module 750 can determine gradient information of dual variables based on the first expected number of exposure times of each candidate display object on the display page, and update the current dual variable by using the gradient information. For operations of the dual variable updating module 750, references are made to the operations as describe above in step 360 with reference to FIG. 3. In an example, the dual variable updating module 750 can update the current dual variable based on the gradient information by using a projected subgradient descent algorithm.

The traffic allocation method and the traffic allocation apparatus according to some embodiments of this specification are described above with reference to FIG. 1A to FIG. 7. The above-mentioned traffic allocation apparatus can be implemented by using hardware, or can be implemented by using software or a combination of hardware and software.

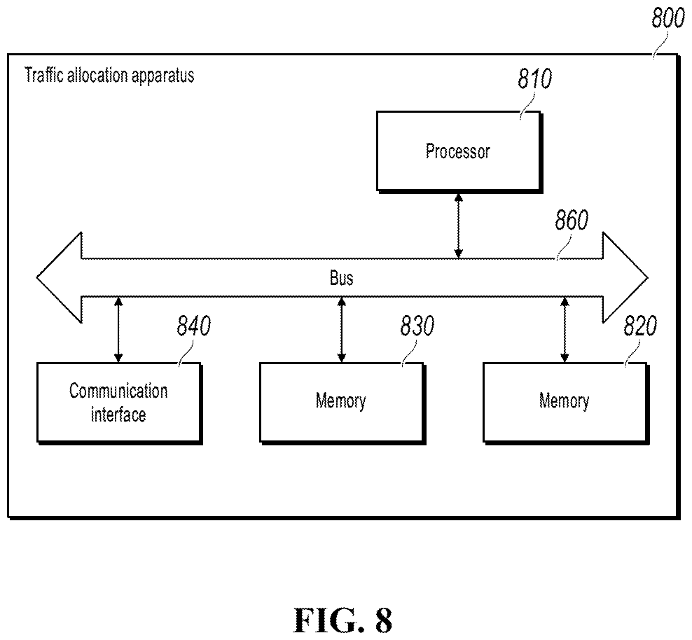

FIG. 8 is an example schematic diagram illustrating a traffic allocation apparatus 800 implemented based on a computer system, according to embodiments of this specification. As shown in FIG. 8, the traffic allocation apparatus 800 can include at least one processor 810, a memory (for example, a non-volatile memory) 820, an internal storage 830, and a communication interface 840, and the at least one processor 810, the memory 820, the internal storage 830, and the communication interface 840 are connected together by using a bus 860. The at least one processor 810 executes at least one computer readable instruction (that is, the above-mentioned element implemented in the form of software) stored or encoded in the memory.

In one or more embodiments, computer-executable instructions are stored in the memory, and when the computer-executable instructions are executed, the at least one processor 810 is enabled to: obtain an exposure probability of each booth and a unit traffic revenue and corresponding unit resource consumption of each candidate display object for each user; construct an optimization objective and a resource consumption constraint corresponding to a multi-booth traffic allocation scheme based on the exposure probability of each booth and the unit traffic revenue and the corresponding unit resource consumption of each candidate display object for each user; and determine a multi-booth traffic allocation scheme when the resource consumption constraint is satisfied and the optimization objective is maximized, where the multi-booth traffic allocation scheme includes a booth allocation scheme of candidate display objects for each user, where the optimization objective includes a sum value of traffic revenues for each user under the multi-booth traffic allocation scheme, the corresponding traffic revenue for each user is determined based on the exposure probability of each booth, a unit traffic revenue of each candidate display object for the user, and a booth allocation scheme of the candidate display objects for the user, the resource consumption constraint includes that a sum of resource consumption corresponding to each user is not greater than a predetermined threshold, and the resource consumption corresponding to each user is determined based on the exposure probability of each booth, unit resource consumption of each candidate display object for the user, and a booth allocation scheme of the candidate display objects for the user.

It should be understood that, when the computer-executable instructions stored in the memory are executed, the at least one processor 810 is enabled to perform the above-mentioned operations and functions described with reference to FIG. 1A to FIG. 7 in the embodiments of this specification.

According to one or more embodiments, a program product such as a machine readable medium (for example, a non-transitory machine readable medium) is provided. The machine readable medium can have instructions (that is, the above-mentioned elements implemented in software form). When the instructions are executed by a machine, the machine performs the above-mentioned operations and functions described with reference to FIG. 1A to FIG. 7 in the embodiments of this specification. Specifically, a system or device equipped with a readable storage medium can be provided, and software program code for implementing a function of any one of the above-mentioned embodiments is stored in the readable storage medium, so a computer or a processor of the system or device reads and executes instructions stored in the readable storage medium.

In this case, the program code read from the readable medium can implement a function of any one of the above-mentioned embodiments. Therefore, the machine readable code and the readable storage medium that stores the machine readable code constitute a part of this disclosure.

Embodiments of the readable storage medium include a floppy disk, a hard disk, a magneto-optical disk, an optical disc (such as a CD-ROM, a CD-R, a CD-RW, a DVD-ROM, a DVD-RAM, a DVD-RW, a DVD-RW), a magnetic tape, a non-volatile memory card, and a ROM. Optionally, program code can be downloaded from a server computer or cloud by a communication network.

According to one or more embodiments, a computer program product is provided, where the computer program product includes a computer program, and when the computer program is executed by a processor, the processor is enabled to perform the above-mentioned operations and functions described with reference to FIG. 1A to FIG. 7 in the embodiments of this specification.

It should be understood by a person skilled in the art that various variations and modifications can be made to the above-mentioned embodiments disclosed without departing from the essence of this application. Therefore, the protection scope of this application should be described by the appended claims.

It is worthwhile to note that, not all steps and units in the above-mentioned processes and system structure diagrams are needed. Some steps or units can be ignored based on actual needs. An execution sequence of each step is not fixed, and can be determined based on needs. The device structure described in the above-mentioned embodiments can be a physical structure, or can be a logical structure, that is, some units can be implemented by a same physical entity, or some units can be implemented by multiple physical entities, or can be implemented jointly by some components in multiple independent devices.

In the above-mentioned embodiments, hardware units or modules can be implemented mechanically or electrically. For example, a hardware unit, module or processor can include permanent dedicated circuits or logic (such as a specialized processor, an FPGA or an ASIC) to complete corresponding operations. The hardware unit or processor can further include programmable logic or circuits (such as general-purpose processors or other programmable processors), which can be temporarily set by software to complete corresponding operations. A specific implementation way (mechanical way, or a dedicated permanent circuit, or a temporarily arranged circuit) can be determined based on the consideration of costs and time.

The specific implementations described above with reference to the accompanying drawings describe example embodiments, but do not represent all embodiments that can be implemented or fall within the protection scope of the claims. The term “example” used throughout this specification means “used as an example, an instance, or an illustration” and does not mean “preferred” or “advantageous” over other embodiments. For the purpose of providing an understanding of the described technology, a specific implementation includes specific details. However, these techniques can be implemented without these specific details. In some examples, well-known structures and devices are shown in block diagrams in order to avoid making it difficult to understand the concepts of the described embodiments.

The above-mentioned description of the content of the disclosure is provided to enable any person of ordinary skill in the art to implement or use the content of the disclosure. It is obvious to a person of ordinary skill in the art that various modifications can be made to the content of the disclosure. In addition, the general principle described here can also be applied to another variant without departing from the protection scope of the content of the disclosure. Therefore, the content of the disclosure is not limited to the examples and designs described here, but is consistent with the widest range of principles and novelty features that conform to the disclosure.

What is claimed is:

1. A computer-implemented method for determining a multi-booth traffic allocation scheme for multiple users, comprising:
obtaining an exposure probability of each booth and a unit traffic revenue and corresponding unit resource consumption of each candidate display object for each user;
constructing an optimization objective and a resource consumption constraint corresponding to a multi-booth traffic allocation scheme based on the exposure probability of each booth and the unit traffic revenue and the corresponding unit resource consumption of each candidate display object for each user; and
determining a multi-booth traffic allocation scheme when the resource consumption constraint is satisfied and the optimization objective is maximized, wherein the multi-booth traffic allocation scheme comprises a booth allocation scheme of candidate display objects for each user, wherein
the optimization objective comprises a sum value of traffic revenues for each user under the multi-booth traffic allocation scheme, corresponding traffic revenues for each user are determined based on the exposure probability of each booth, a unit traffic revenue of each candidate display object for the user, and a booth allocation scheme of candidate display objects for the user, the resource consumption constraint comprises that a sum of resource consumption corresponding to each user is not greater than a predetermined threshold, and resource consumption corresponding to each user is determined based on the exposure probability of each booth, unit resource consumption of each candidate display object for the user, and a booth allocation scheme of candidate display objects for the user.

2. The computer-implemented method of claim 1, wherein the optimization objective comprises a sum value of traffic revenues and content information entropy for each user under the multi-booth traffic allocation scheme.

3. The computer-implemented method of claim 2, wherein in the optimization objective, a trade-off parameter is set between the traffic revenues and the content information entropy for each user.

4. The computer-implemented method of claim 1, wherein determining a multi-booth traffic allocation scheme when the resource consumption constraint is satisfied and the optimization objective is maximized, comprises:
determining the multi-booth traffic allocation scheme by using a random arrangement model when the resource consumption constraint is satisfied and the optimization objective is maximized.

5. The computer-implemented method of claim 4, wherein determining the multi-booth traffic allocation scheme by using a random arrangement model when the resource consumption constraint is satisfied and the optimization objective is maximized, comprises:
sequentially determining a traffic allocation scheme for each user based on a user arrival order in the random arrangement model.

6. The computer-implemented method of claim 5, comprising:
receiving a random traffic allocation request from a current arriving user, wherein the random traffic allocation request comprises a unit traffic revenue and corresponding unit resource consumption of each candidate display object for the current arriving user.

7. The computer-implemented method of claim 6, comprising:
determining a first expected number of exposure times of each candidate display object on a display page by using an efficient pooling projection algorithm based on a current dual variable and the unit traffic revenue and the corresponding unit resource consumption of each candidate display object for the current arriving user.

8. The computer-implemented method of claim 7, comprising:
determining a second expected number of exposure times of each candidate display object on the display page based on a remaining resource consumption limit; and
restoring a booth allocation scheme of candidate display objects for the current arriving user by using a roulette exchange allocation algorithm based on the second expected number of exposure times of each candidate display object on the display page.

9. The computer-implemented method of claim 8, comprising:
updating, as an updated current dual variable, the current dual variable based on the first expected number of exposure times of each candidate display object on the display page, wherein the updated current dual variable serves as a current dual variable in a next process for determining a traffic allocation scheme.

10. The computer-implemented method of claim 9, wherein updating the current dual variable based on the first expected number of exposure times of each candidate display object on the display page, comprises:
determining gradient information of dual variables based on the first expected number of exposure times of each candidate display object on the display page.

11. The computer-implemented method of claim 10, comprising:
updating the current dual variable based on the gradient information of dual variables by using a projected subgradient descent algorithm.

12. The computer-implemented method of claim 9, wherein determining a first expected number of exposure times of each candidate display object on a display page by using an efficient pooling projection algorithm based on a current dual variable and the unit traffic revenue and the corresponding unit resource consumption of each candidate display object for the current arriving user, comprises:
arranging candidate display objects in a candidate display object set for the current arriving user in descending order based on a contribution value of a maximum objective of the candidate display objects.

13. The computer-implemented method of claim 12, comprising:
dividing the candidate display objects arranged in descending order into blocks to obtain initial display object blocks; and
determining an efficiency value of each initial display object block based on a contribution value of a maximum objective and an exposure probability of each display object in the initial display object block.

14. The computer-implemented method of claim 13, comprising:
cyclically performing the following process until efficiency values of all display object blocks in a display object block set for the current arriving user are strictly decreased in sequence:
determining whether a display object block whose efficiency value is not great than an efficiency value of a display object block immediately following the display object block exists in a current display object block set.

15. The computer-implemented method of claim 14, comprising:
in response to existence of a display object block whose efficiency value is not greater than an efficiency value of a display object block immediately following the display object block, merging the display object block and the display object block immediately following the display object block into a new display object block, and determining an efficiency value of the new display object block based on a contribution value of a maximum objective of each display object in the new display object block for the current arriving user and an exposure probability of each display object.

16. The computer-implemented method of claim 14, comprising:
in response to nonexistence of a display object block whose efficiency value is not greater than an efficiency value of a display object block immediately following the display object block, determining the first expected number of exposure times of each candidate display object on the display page based on an efficiency value of a display object block comprising each display object and a contribution value of a maximum objective of each candidate display object for the current arriving user.

17. The computer-implemented method of claim 9, wherein restoring a booth allocation scheme of candidate display objects for the current arriving user by using a roulette exchange allocation algorithm based on the second expected number of exposure times of each candidate display object on the display page, comprises:
cyclically performing the following process for each candidate display object in the candidate display object set for the current arriving user; in response to a number of allocated exposure times of current candidate display objects being greater than a second expected number of exposure times of the current candidate display objects, merging the current candidate display objects into a display object index set to be exchanged.

18. The computer-implemented method of claim 9, wherein restoring a booth allocation scheme of candidate display objects for the current arriving user by using a roulette exchange allocation algorithm based on the second expected number of exposure times of each candidate display object on the display page, comprises:
in response to a number of allocated exposure times of current candidate display objects being not greater than a second expected number of exposure times of the current candidate display objects, performing, based on an exchange probability between the current candidate display objects and each display object in a display object index set, booth exchange between the current candidate display objects and the display objects in the display object index set in a roulette exchange way, updating the number of allocated exposure times of the current candidate display objects to the second expected number of exposure times of the current candidate display objects, updating a number of allocated exposure times of the exchanged display objects based on the number of allocated exposure times and an exchange probability of the exchanged display objects and the number of allocated exposure times of the current candidate display objects, and removing the exchanged display objects from the display object index set to be exchanged when the updated number of allocated exposure times of the exchanged display objects is equal to a second expected number of exposure times of the exchanged display objects.

19. A non-transitory, computer-readable medium storing one or more instructions executable by a computer system to perform one or more operations for determining a multi-booth traffic allocation scheme for multiple users, comprising:
obtaining an exposure probability of each booth and a unit traffic revenue and corresponding unit resource consumption of each candidate display object for each user;
constructing an optimization objective and a resource consumption constraint corresponding to a multi-booth traffic allocation scheme based on the exposure probability of each booth and the unit traffic revenue and the corresponding unit resource consumption of each candidate display object for each user; and
determining a multi-booth traffic allocation scheme when the resource consumption constraint is satisfied and the optimization objective is maximized, wherein the multi-booth traffic allocation scheme comprises a booth allocation scheme of candidate display objects for each user, wherein
the optimization objective comprises a sum value of traffic revenues for each user under the multi-booth traffic allocation scheme, corresponding traffic revenues for each user are determined based on the exposure probability of each booth, a unit traffic revenue of each candidate display object for the user, and a booth allocation scheme of candidate display objects for the user, the resource consumption constraint comprises that a sum of resource consumption corresponding to each user is not greater than a predetermined threshold, and resource consumption corresponding to each user is determined based on the exposure probability of each booth, unit resource consumption of each candidate display object for the user, and a booth allocation scheme of candidate display objects for the user.

20. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations for determining a multi-booth traffic allocation scheme for multiple users, comprising:
obtaining an exposure probability of each booth and a unit traffic revenue and corresponding unit resource consumption of each candidate display object for each user;
constructing an optimization objective and a resource consumption constraint corresponding to a multi-booth traffic allocation scheme based on the exposure probability of each booth and the unit traffic revenue and the corresponding unit resource consumption of each candidate display object for each user; and
determining a multi-booth traffic allocation scheme when the resource consumption constraint is satisfied and the optimization objective is maximized, wherein the multi-booth traffic allocation scheme comprises a booth allocation scheme of candidate display objects for each user, wherein
the optimization objective comprises a sum value of traffic revenues for each user under the multi-booth traffic allocation scheme, corresponding traffic revenues for each user are determined based on the exposure probability of each booth, a unit traffic revenue of each candidate display object for the user, and a booth allocation scheme of candidate display objects for the user, the resource consumption constraint comprises that a sum of resource consumption corresponding to each user is not greater than a predetermined threshold, and resource consumption corresponding to each user is determined based on the exposure probability of each booth, unit resource consumption of each candidate display object for the user, and a booth allocation scheme of candidate display objects for the user.
